(19) United States
(12) Patent Application Publication
(10) Pub. No.: US 2025/0294251 A1
(43) Pub. Date: Sep. 18, 2025

(54) FOCUS CONTROL DEVICE, OPERATION METHOD OF FOCUS CONTROL DEVICE, OPERATION PROGRAM OF FOCUS CONTROL DEVICE, AND IMAGING APPARATUS

(71) Applicant: FUJIFILM Corporation, Tokyo (JP)

(72) Inventor: Hideaki KOKUBUN, Saitama (JP)

(73) Assignee: FUJIFILM Corporation, Tokyo (JP)

(21) Appl. No.: 19/080,914

(22) Filed: Mar. 16, 2025

(30) Foreign Application Priority Data
Mar. 18, 2024 (JP) 2024-042844

(51) Int. Cl. H04N 23/67

(52) U.S. Cl. CPC H04N 23/672

(57) ABSTRACT

A focus adjustment unit acquires a current position of a focus lens on an optical axis by deriving the current position based on a drive amount. A focus derivation unit acquires an estimated focusing position. A speed setting unit sets a moving speed to a first speed in a case in which an absolute value of a difference between the current position and the estimated focusing position is less than a threshold value. A focus lens drive controller moves the focus lens at the first speed. The speed setting unit sets the moving speed to a second speed lower than the first speed in a case in which the absolute value of the difference between the current position and the estimated focusing position is equal to or greater than the threshold value. The focus lens drive controller moves the focus lens at the second speed.

### CROSS-REFERENCE TO RELATED APPLICATIONS

The present application claims priority under 35 U.S.C. § 119 to Japanese Patent Application No. 2024-042844, filed on Mar. 18, 2024. The above application is hereby expressly incorporated by reference, in its entirety, into the present application.

### BACKGROUND

### 1. Technical Field

The present disclosed technology relates to a focus control device, an operation method of a focus control device, an operation program of a focus control device, and an imaging apparatus.

### 2. Description of the Related Art

JP2008-233668A discloses an autofocus system that performs autofocus control of controlling a focus of an imaging optical system of a camera so that the imaging optical system is in an in-focus state. The autofocus system comprises a focus moving amount information acquisition unit and a focus moving speed change unit. The focus moving amount information acquisition unit acquires information related to a moving amount of the focus until the imaging optical system is in the in-focus state from a current focus state. The focus moving speed change unit sets a moving speed of the focus in a case in which the camera is stopped in a front-back direction with respect to a subject to be in focus by an autofocus unit as a reference speed, and changes, with respect to the reference speed, a moving speed of the focus at which the imaging optical system is switched from the current focus state to the in-focus state, based on information acquired by the focus moving amount information acquisition unit. The focus moving speed change unit sets the focus moving speed to be faster than a reference speed in a case in which the moving amount of the focus until the in-focus state is reached increases as the camera moves in the front-back direction, and sets the focus moving speed to be lower than the reference speed in a case in which the moving amount of the focus is decreased.

### SUMMARY

One embodiment according to the present disclosed technology provides a focus control device, an operation method of a focus control device, an operation program of a focus control device, and an imaging apparatus, with which a variation of a position of a focus lens can be suppressed, the variation occurring in a case in which a subject distance is greatly changed.

The present disclosure relates to a focus control device that performs focus control of a focus lens based on output from a phase-difference detection pixel, the focus control device comprising: a processor, in which the processor is configured to: acquire a current position of the focus lens and an estimated focusing position of the focus lens derived in a case in which the focus lens is located at the current position; move the focus lens at a first speed in a case in which an absolute value of a difference between the current position and the estimated focusing position is less than a first threshold value; and move the focus lens at a second speed lower than the first speed in a case in which the absolute value of the difference between the current position and the estimated focusing position is equal to or greater than the first threshold value.

It is preferable that an absolute value of a difference between the current position and the estimated focusing position, in which phase-difference detection accuracy is out of a set range, is set as the first threshold value.

It is preferable that the processor is configured to: set the second speed to a speed at which derivation of the estimated focusing position is able to be performed a set number of times while the focus lens is being moved, based on the absolute value of the difference between the current position and the estimated focusing position and the number of times of derivation of the estimated focusing position per unit time.

It is preferable that the set number of times is changed in accordance with the absolute value of the difference between the current position and the estimated focusing position.

It is preferable that the processor is configured to: change a moving speed of the focus lens based on the estimated focusing position in a case in which the absolute value of the difference between the current position and the estimated focusing position is less than a second threshold value, in a case in which the absolute value of the difference between the current position and the estimated focusing position is less than the second threshold value while the focus lens is being moved at the second speed.

It is preferable that the processor is configured to: derive the estimated focusing position a plurality of times while the focus lens is being moved at the second speed; and stop movement of the focus lens in a case in which an absolute value of a difference between a previous estimated focusing position and a current estimated focusing position is less than a third threshold value.

It is preferable that the processor is configured to: stop movement of the focus lens in a case in which it is determined that the current position passes beyond the estimated focusing position while the focus lens is being moved at the second speed.

It is preferable that the processor is configured to: determine that the current position passes beyond the estimated focusing position in a case in which a sign of the difference between the current position and the estimated focusing position is reversed.

It is preferable that the processor is configured to: cause the focus lens to stay at the current position in a case in which the absolute value of the difference between the current position and the estimated focusing position is less than a fourth threshold value; and move the focus lens in a case in which the absolute value of the difference between the current position and the estimated focusing position is equal to or greater than the fourth threshold value.

The present disclosure relates to an operation method of a focus control device that performs focus control of a focus lens based on output from a phase-difference detection pixel, the operation method comprising: acquiring a current position of the focus lens and an estimated focusing position of the focus lens derived in a case in which the focus lens is located at the current position; moving the focus lens at a first speed in a case in which an absolute value of a difference between the current position and the estimated focusing position is less than a first threshold value; and moving the focus lens at a second speed lower than the first speed in a case in which the absolute value of the difference between the current position and the estimated focusing position is equal to or greater than the first threshold value.

The present disclosure relates to an operation program of a focus control device that performs focus control of a focus lens based on output from a phase-difference detection pixel, the operation program causing a computer to execute a process comprising: acquiring a current position of the focus lens and an estimated focusing position of the focus lens derived in a case in which the focus lens is located at the current position; moving the focus lens at a first speed in a case in which an absolute value of a difference between the current position and the estimated focusing position is less than a first threshold value; and moving the focus lens at a second speed lower than the first speed in a case in which the absolute value of the difference between the current position and the estimated focusing position is equal to or greater than the first threshold value.

The present disclosure relates to an imaging apparatus comprising: the focus control device described above.

### BRIEF DESCRIPTION OF THE DRAWINGS

Exemplary embodiments according to the technique of the present disclosure will be described in detail based on the following figures, wherein:

FIG. 1 is a diagram showing a configuration of an imaging apparatus;

FIG. 2 is a diagram showing an arrangement of pixels of an imaging element;

FIG. 3 is a diagram showing a configuration of a normal pixel;

FIG. 4 is a diagram showing a configuration of a first phase-difference detection pixel;

FIG. 5 is a diagram showing a configuration of a second phase-difference detection pixel;

FIG. 6 is a graph showing a phase difference between a first calculation signal and a second calculation signal;

FIG. 7 is a block diagram showing a detailed configuration of a controller;

FIG. 8 is a block diagram showing a processing unit of a CPU;

FIG. 9 is a diagram showing a scene in which a subject distance is changed greatly, and (A) shows a case in which a mountain in a distant view is used as a subject and (B) shows a case in which the subject is switched from the mountain in the distant view to a person in a near view;

FIG. 10 is a graph showing a relationship between the phase difference and a defocus amount;

FIG. 11 is a diagram showing transitions of a current position and an estimated focusing position of a focus lens in a related-art example in a case in which the distant view is switched to a near view A;

FIG. 12 is a diagram showing processing of a speed setting unit that sets a moving speed of the focus lens in accordance with a comparison result between an absolute value of a difference between the current position and the estimated focusing position of the focus lens and a threshold value, in which (A) shows a case in which the absolute value of the difference between the current position and the estimated focusing position of the focus lens is less than the threshold value, and (B) shows a case in which the absolute value of the difference between the current position and the estimated focusing position of the focus lens is equal to or greater than the threshold value;

FIG. 13 is a graph showing a relationship between the absolute value of the difference between the current position of the focus lens and the estimated focusing position and a set number of times;

FIG. 14 is a diagram showing processing of a focus lens drive controller that determines whether or not to cause the focus lens to stay at the current position in accordance with the comparison result between the absolute value of the difference between the current position of the focus lens and the estimated focusing position and the threshold value, in which (A) shows a case in which the absolute value of the difference between the current position and the estimated focusing position of the focus lens is less than the threshold value, and (B) shows a case in which the absolute value of the difference between the current position and the estimated focusing position of the focus lens is equal to or greater than the threshold value;

FIG. 15 is a diagram showing transitions of the current position and the estimated focusing position of the focus lens in a case in which the distant view is switched to a near view B;

FIG. 16 is a diagram showing transitions of the current position and the estimated focusing position of the focus lens in a case in which the distant view is switched to the near view A;

FIG. 17 is a flowchart showing a processing procedure of the controller;

FIG. 18 is a flowchart showing the processing procedure of the controller;

FIG. 19 is a diagram showing an example of a stop determination of the focus lens in a model in which the estimated focusing position cannot be updated while the focus lens is being moved;

FIG. 20 is a diagram showing another example of the stop determination of the focus lens in the model in which the estimated focusing position cannot be updated while the focus lens is being moved; and

FIG. 21 is a diagram showing a third embodiment in which the moving speed of the focus lens is changed based on the estimated focusing position in a case in which the absolute value of the difference between the current position and the estimated focusing position of the focus lens is less than a threshold value.

### DETAILED DESCRIPTION

### First Embodiment

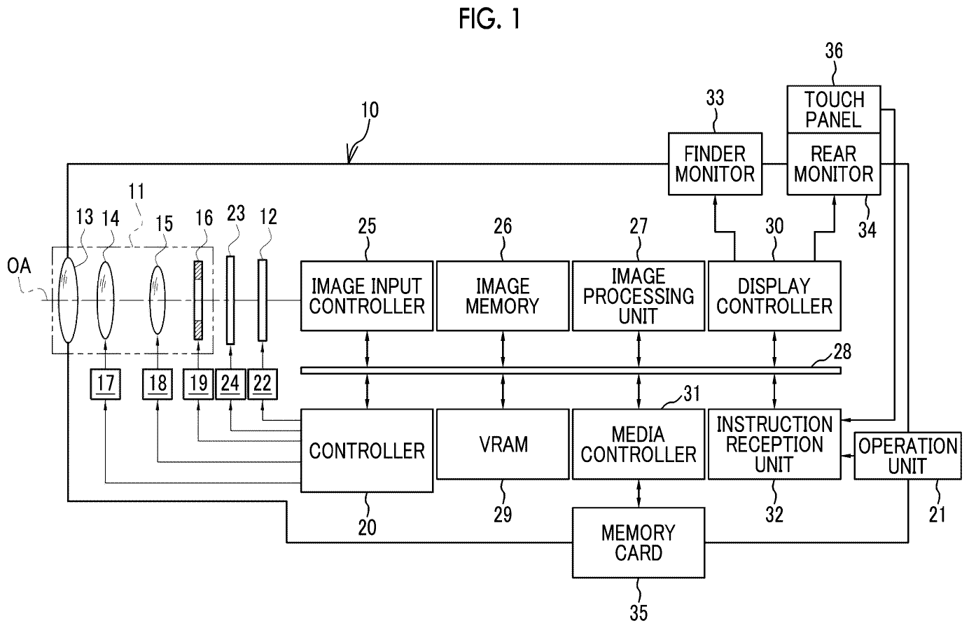

As shown in FIG. 1 as an example, an imaging apparatus 10 is, for example, a mirrorless single-lens digital camera, and comprises an imaging optical system 11 and an imaging element 12. The imaging optical system 11 includes a plurality of types of lenses for forming an image of subject light on the imaging element 12. Specifically, the imaging optical system 11 includes an objective lens 13, a focus lens 14, and a zoom lens 15. Each of these lenses 13 to 15 is disposed in this order from an object side (subject side) toward an image-forming side (imaging element 12 side). Although shown in FIG. 1 in a simplified manner, each of the lenses 13 to 15 is actually a lens group in which a plurality of lenses are combined. The imaging optical system 11 also includes a stop 16. The stop 16 is disposed closest to the image-forming side in the imaging optical system 11. It should be noted that the imaging apparatus 10 may be a type in which a lens barrel with a built-in imaging optical system 11 and the like is integrated with a body with the built-in imaging element 12 and the like, or may be a so-called lens interchangeable type in which the lens barrel and the body are separate bodies.

The focus lens 14 is provided with a focus lens drive mechanism 17, the zoom lens 15 is provided with a zoom lens drive mechanism 18, and the stop 16 is provided with a stop drive mechanism 19. The focus lens drive mechanism 17 includes a focusing cam ring that holds the focus lens 14 and is formed with a cam groove on the outer periphery, a focusing motor that rotates the focusing cam ring about an optical axis OA to move the focusing cam ring along the optical axis OA, a driver of the focusing motor, and the like. Similarly, the zoom lens drive mechanism 18 includes a zooming cam ring that holds the zoom lens 15 and is formed with a cam groove on the outer periphery, a zooming motor that rotates the zooming cam ring about an optical axis OA to move the zooming cam ring along the optical axis OA, a driver of the zooming motor, and the like. The stop drive mechanism 19 includes a stop motor that opens and closes a plurality of stop leaf blades of the stop 16, a driver of the stop motor, and the like.

The focusing motor, the zooming motor, and the stop motor are, for example, stepping motors. In this case, a position of the focus lens 14 and a position of the zoom lens 15 on the optical axis OA and an aperture of the stop 16 can be derived from drive amounts of the focusing motor, the zooming motor, and the stop motor. It should be noted that a position sensor may be provided to detect the positions of the focus lens 14 and the zoom lens 15, instead of the drive amounts of the focusing motor and the zooming motor.

The electric components such as the motor or the driver of each of the drive mechanisms 17 to 19 are connected to a controller 20. The electric components of each of the drive mechanisms 17 to 19 are driven under the control of the controller 20. More specifically, the controller 20 issues a drive signal in response to an instruction from a user, which is input via an operation unit 21, to drive the electric components of each of the drive mechanisms 17 to 19. For example, in a case in which an instruction to change an angle of view to a telephoto side is input via an angle-of-view change switch of the operation unit 21, the controller 20 issues the drive signal to move the zoom lens 15 to the telephoto side to the driver of the zooming motor of the zoom lens drive mechanism 18.

The focusing motor, the zooming motor, and the stop motor output the drive amounts to the controller 20. The controller 20 derives the position of the focus lens 14 and the position of the zoom lens 15 on the optical axis OA and the aperture of the stop 16 based on the drive amounts.

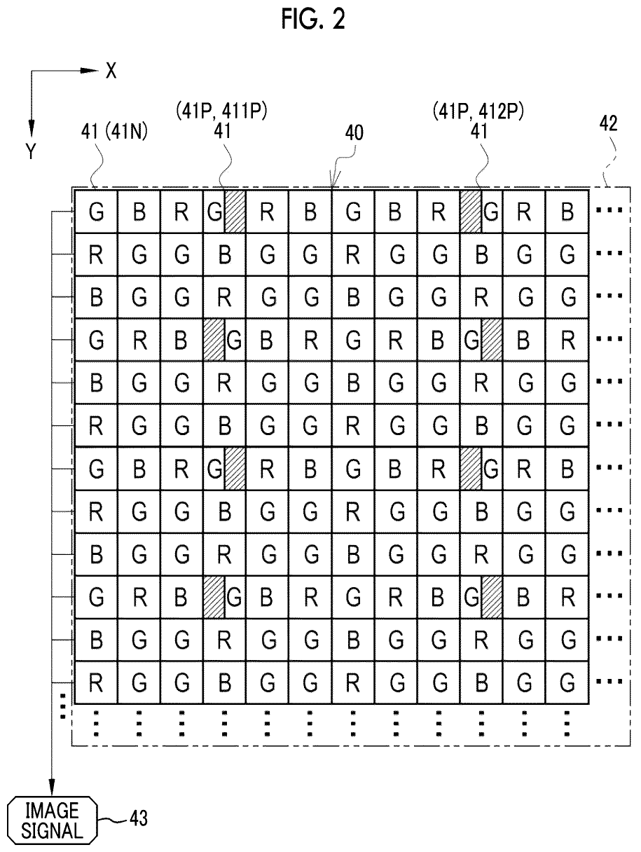

The imaging element 12 is, for example, a complementary metal-oxide-semiconductor (CMOS) image sensor, and has an imaging face 42 (see FIG. 2) that images the subject light. The imaging element 12 is disposed such that a center of the imaging face 42 matches the optical axis OA, and the imaging face 42 is orthogonal to the optical axis OA. It should be noted that the terms “match” and “orthogonal” used herein mean not only perfect match and orthogonality but also match and orthogonality in a sense including an error generally allowed in the technical field to which the present disclosed technology belongs.

An imaging element driver 22 is connected to the imaging element 12. The imaging element driver 22 is connected to the controller 20. The imaging element driver 22 performs, under the control of the controller 20, supply of a vertical scanning signal and a horizontal scanning signal to the imaging element 12 or the like to control an imaging timing of the subject light by the imaging element 12.

A shutter 23 is provided between the imaging optical system 11 and the imaging element 12. The shutter 23 is, for example, a focal-plane shutter including a front curtain and a rear curtain. A shutter drive mechanism 24 is connected to the shutter 23. The shutter drive mechanism 24 includes an electromagnet that holds the front curtain and the rear curtain and releases the holding thereof to cause the front curtain and the rear curtain to travel, a driver of the electromagnet, and the like. The shutter drive mechanism 24 is driven, under the control of the controller 20, to open and close the shutter 23.

The controller 20 is connected to the respective units, such as an image input controller 25, an image memory 26, and an image processing unit 27, through a busline 28. In addition, the busline 28 is connected to a video random-access memory (VRAM) 29, a display controller 30, a media controller 31, an instruction reception unit 32, and the like. It should be noted that, although not shown, the busline 28 is also connected to a strobe drive controller that controls the drive of a strobe device, an external communication interface (I/F) for communicating with an external device via a connection terminal such as a universal serial bus (USB) terminal, or a wireless communication I/F.

Image data obtained by imaging the subject light is input to the image input controller 25 from the imaging element 12. The image input controller 25 outputs the image data to the image memory 26. The image memory 26 is, for example, a synchronous dynamic random-access memory (SDRAM), and temporarily stores the image data.

The image processing unit 27 reads out unprocessed image data from the image memory 26. The image processing unit 27 performs various types of image processing on the image data. Examples of the various types of image processing include offset correction processing, sensitivity correction processing, pixel interpolation processing, white balance correction processing, gamma correction processing, demosaicing processing, generation processing of a brightness signal and a color difference signal, contour enhancement processing, and color correction processing. The image processing unit 27 writes the image data, which has been subjected to the various types of image processing, back to the image memory 26.

The image data, which has been subjected to the various types of image processing and is displayed as a live view image (also referred to as live preview image), is input into the VRAM 29 from the image memory 26. The VRAM 29 has a region for storing the image data for two consecutive frames. The image data stored in the VRAM 29 is sequentially rewritten with new image data. The VRAM 29 sequentially outputs newer image data of the image data for two consecutive frames to the display controller 30.

The display controller 30 has a so-called video encoder function of converting the image data from the VRAM 29 into video data and outputting the converted video data to any one of a finder monitor 33 or a rear monitor 34. Accordingly, the user can visually recognize the live view image through any one of the finder monitor 33 or the rear monitor 34. A display frame rate of the live view image is, for example, 60 frames per second (fps).

It should be noted that whether to output the video data to the finder monitor 33 or the rear monitor 34 is decided on as follows, for example. That is, a pupil detection sensor is provided in a finder. In a case in which the pupil detection sensor detects that the user looks into the finder, the video data is output to the finder monitor 33. On the contrary, in a case in which the pupil detection sensor detects that the user does not look into the finder, the video data is output to the rear monitor 34.

In a case in which an instruction to start capturing of a still image or a video is issued by a full-press operation on a release button of the operation unit 21, the image processing unit 27 performs compression processing on the image data of the image memory 26. In a case of the still image, the image processing unit 27 performs, for example, compression processing of a joint photographic experts group (JPEG) format on the image data. In a case of the video, the image processing unit 27 performs, for example, compression processing of a moving picture experts group (MPEG) format on the image data. The image processing unit 27 outputs the image data, which has been subjected to the compression processing, to the media controller 31.

The media controller 31 records the image data, which has been subjected to the compression processing, from the image processing unit 27 in a memory card 35. The memory card 35 is attachably and detachably mounted in a memory card slot (not shown).

In a case in which an image playback mode is selected via a mode selector switch of the operation unit 21, the media controller 31 reads out the image data from the memory card 35 to output the read out image data to the image processing unit 27. The image processing unit 27 performs decompression processing on the image data from the memory card 35. The image processing unit 27 outputs the image data, which has been subjected to the decompression processing, to the display controller 30. The display controller 30 converts the image data into the video data to output the converted video data to the rear monitor 34. Accordingly, the user can visually recognize a playback image through the rear monitor 34.

The instruction reception unit 32 receives various operation instructions input from the user via a touch panel 36 that is integrally provided with the operation unit 21 and the rear monitor 34. The instruction reception unit 32 outputs the received various operation instructions to the controller 20 through the busline 28.

As described above, the operation unit 21 includes the angle-of-view change switch, the release button, and the mode selector switch. The release button is a two-stage press button for performing a half-press operation and the full-press operation. An instruction to prepare the capturing of the still image or the video is issued by the half-press operation on the release button, and the instruction to start the capturing of the still image or the video is issued by the full-press operation of the release button. In addition to these buttons, the operation unit 21 further includes a menu button for displaying various setting menus on the rear monitor 34, a cross key used for numerical value setting and switching of options, a confirm button that is operated in a case of confirming the setting, and the like. The touch panel 36 is superimposed on a display surface of the rear monitor 34. The touch panel 36 detects the contact with a finger of the user or a dedicated indicator such as a stylus pen, to recognize the various operation instructions from the user.

Modes that can be switched by the mode selector switch include a still image capturing mode, a video capturing mode, an image playback mode, a setting mode, and the like. The still image capturing mode includes not only a normal imaging mode in which one still image is captured but also a consecutive imaging mode in which the still images are consecutively captured at a predetermined imaging interval (for example, a frame rate of 5 fps to 10 fps). The consecutive imaging mode is activated, for example, in a case in which a fully-pressed state of the release button continues for a predetermined time or longer (for example, one second or longer). The consecutive imaging mode ends in a case in which the fully-pressed state of the release button is released.

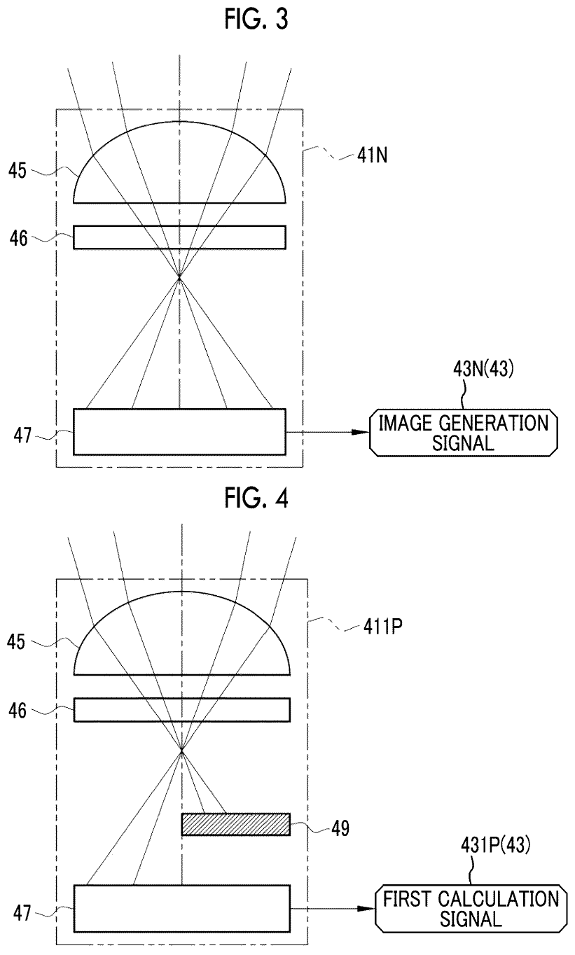

As shown in FIG. 2 as an example, the imaging element 12 is provided with a photoelectric conversion unit 40. The photoelectric conversion unit 40 is formed by a plurality of pixels 41 two-dimensionally arranged along an X-direction and a Y-direction. The plurality of pixels 41 form the imaging face 42. As is well known, the pixel 41 is formed by a micro lens 45, a color filter 46, and a photoelectric conversion element 47 such as a photodiode (see FIGS. 3 to 5). It should be noted that the X-direction and the Y-direction are a horizontal direction and a vertical direction in a state in which a bottom surface of the imaging apparatus 10 is placed on a horizontal plane.

A scanning line parallel to the X-direction is wired between rows of the pixels 41. Further, a signal line parallel to the Y-direction is wired between columns of the pixels 41. The pixel 41 (photoelectric conversion element 47 thereof) is connected to the signal line via an amplifier and a switch. The scanning line is also connected to the switch. In a case of an accumulation operation that accumulates a signal charge in accordance with the subject light in the pixel 41 (photoelectric conversion element 47 thereof), an OFF signal is supplied as the vertical scanning signal through the scanning line to turn off the switch. In a case of a readout operation that reads out an image signal (voltage signal) 43 in accordance with the signal charge from the pixel 41 (photoelectric conversion element 47 thereof), an ON signal is supplied as the vertical scanning signal through the scanning line to turn on the switch. A terminal of the signal line is connected to a correlated double sampling (CDS) circuit and an analog-to-digital converter (ADC) circuit. The CDS circuit performs sampling two correlation pile on the image signal 43 input through the signal line. The ADC circuit converts the image signal 43, which has been subjected to the sampling two correlation pile, into a digital image signal 43.

The pixels 41 are divided, depending on types of the color filter 46, into three types of a green pixel (denoted by “G” in FIG. 2) having sensitivity to light in a green wavelength range, a red pixel (denoted by “R” in FIG. 2) having sensitivity to light in a red wavelength range, and a blue pixel (denoted by “B” in FIG. 2) having sensitivity to light in a blue wavelength range. The three types of the pixels 41 are regularly arranged in a predetermined array. As the predetermined array, a so-called Bayer array is described in which two green pixels, one blue pixel, and one red pixel are arranged in vertical and horizontal 2×2 pixels.

The pixels 41 include a normal pixel 41N and a phase-difference detection pixel 41P. The phase-difference detection pixels 41P further include a first phase-difference detection pixel 411P and a second phase-difference detection pixel 412P. There is three types of the normal pixel 41N, such as the green pixel, the blue pixel, and the red pixel, but the phase-difference detection pixel 41P is only the green pixel.

The phase-difference detection pixels 41P are arranged at predetermined intervals in the X-direction and the Y-direction. In FIG. 2, the phase-difference detection pixels 41P are arranged at an interval of five pixels in the X-direction and at an interval of two pixels in the Y-direction. Further, as the phase-difference detection pixels 41P, the first phase-difference detection pixel 411P and the second phase-difference detection pixel 412P are arranged to alternately appear in the X-direction and the Y-direction. For example, in a case of a fourth row, the phase-difference detection pixels 41P are arranged, from left to right, in an order of the second phase-difference detection pixel 412P, the first phase-difference detection pixel 411P, and the like. Further, for example, in a case of a tenth column, the phase-difference detection pixels 41P are arranged, from top to bottom, in an order of the second phase-difference detection pixel 412P, the first phase-difference detection pixel 411P, the second phase-difference detection pixel 412P, the first phase-difference detection pixel 411P, and the like. The first phase-difference detection pixel 411P and the second phase-difference detection pixel 412P adjacent to each other in the X-direction and the Y-direction constitute one set for detecting a phase difference α (see FIG. 6).

As shown in FIGS. 3 to 5 as an example, the normal pixel 41N, the first phase-difference detection pixel 411P, and the second phase-difference detection pixel 412P have the same basic configuration, and are formed by the micro lens 45, the color filter 46, and the photoelectric conversion element 47, which are disposed in order from the object side.

As shown in FIG. 3, the photoelectric conversion element 47 of the normal pixel 41N outputs, as the image signal 43, an image generation signal 43N in accordance with the subject light that is condensed by the micro lens 45 and transmitted through the color filter 46. The image generation signal 43N is stored in the image memory 26 as a part of the image data.

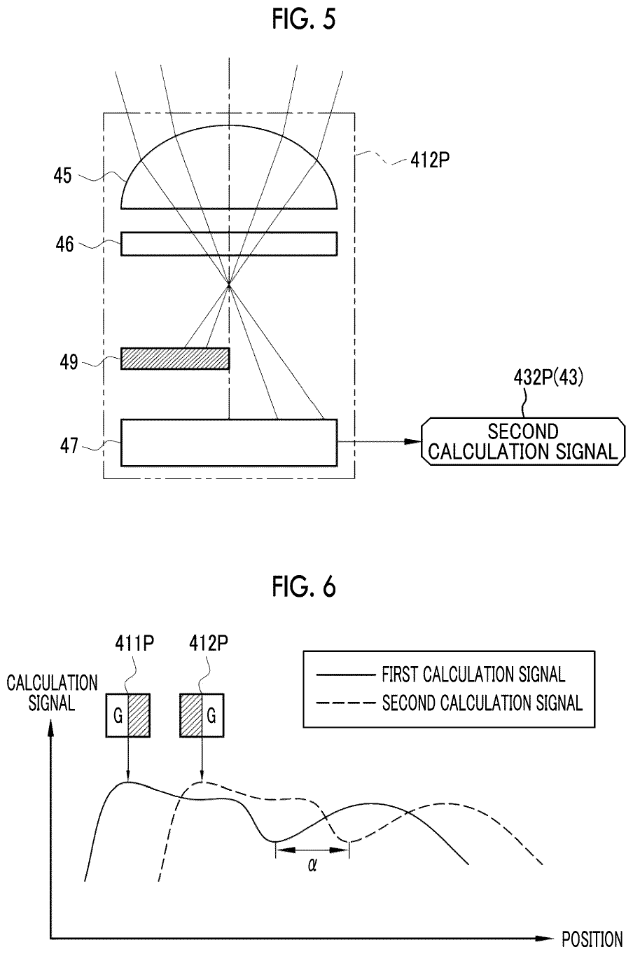

As shown in FIGS. 4 and 5, a light shielding member 49 is disposed between the color filter 46 and the photoelectric conversion element 47 of the first phase-difference detection pixel 411P and the second phase-difference detection pixel 412P. The light shielding member 49 is not disposed in the normal pixel 41N. The light shielding member 49 of the first phase-difference detection pixel 411P shields a right half of the photoelectric conversion element 47, as seen from the object side. On the contrary, the light shielding member 49 of the second phase-difference detection pixel 412P shields a left half of the photoelectric conversion element 47, as seen from the object side.

The photoelectric conversion element 47 of the first phase-difference detection pixel 411P outputs, as the image signal 43, a first calculation signal 431P in accordance with the subject light that is condensed by the micro lens 45 and transmitted through the color filter 46, and that has the right half shielded by the light shielding member 49. On the contrary, the photoelectric conversion element 47 of the second phase-difference detection pixel 412P outputs, as the image signal 43, a second calculation signal 432P in accordance with the subject light that is condensed by the micro lens 45 and transmitted through the color filter 46, and that has the left half shielded by the light shielding member 49. The first calculation signal 431P and the second calculation signal 432P are stored in the image memory 26 as a part of the image data, as in the image generation signal 43N. The first calculation signal 431P and the second calculation signal 432P are examples of “output from phase-difference detection pixel” according to the present disclosed technology. It should be noted that, hereinafter, in a case in which there is no need to particularly distinguish the signals from each other, the first calculation signal 431P and the second calculation signal 432P are collectively referred to as a calculation signal 43P.

As shown in FIG. 6 as an example, the phase difference α appears between the first calculation signal 431P and the second calculation signal 432P, which are output from the first phase-difference detection pixel 411P and the second phase-difference detection pixel 412P adjacent to each other in the X-direction and the Y-direction. With the phase difference α, it is possible to know a moving direction and a moving amount of the focus lens 14 for obtaining a focusing position. The imaging apparatus 10 performs automatic focus control of deriving an estimated focusing position of the focus lens 14 based on the phase difference α, and automatically moving the focus lens 14 to the estimated focusing position.

A region for deriving the estimated focusing position (hereinafter, referred to as a focus adjustment region) is a region set in advance in a central portion of the imaging face 42. In addition, the focus adjustment region may be a region designated by the user, or a region surrounding a specific subject recognized by a well-known subject recognition technology. The specific subject is a pupil, a face, or a body of a person, a pupil, a face, or a body of an animal, or a head, a body, or the like of a vehicle such as an automobile, a railway vehicle, or an airplane. Here, the pupil of the person or the animal is a pupil, that is, a so-called iris. The face of the person or the animal is a portion having, for example, a forehead, chews, a chin, eyes, a nose, a mouth, and ears. The body of the person or the animal is a portion excluding a head, a neck, limbs, and a tail. The head of the vehicle is a front body in a case of the automobile, a portion of a head car having a destination display, a front window, a headlight, or the like in a case of the railway car, and a nose portion having a radome, front window, or the like in a case of the airplane. The body of the vehicle is the entire body excluding wheels in a case of the automobile, the entire body excluding wheels in a case of the railway car regardless of whether the car is a head car, an intermediate car, or a last car, and the entire body excluding a head, main wings, a caudal wing, and the like in a case of the airplane.

The image generation signal 43N is used to generate an image such as the live view image, as known from the name thereof. On the contrary, the calculation signal 43P is used only to calculate the phase difference α and is not used to generate the image. Therefore, in the pixel interpolation processing, the image processing unit 27 interpolates a pixel value of the phase-difference detection pixel 41P by using the image generation signals 43N of the normal pixels 41N around the phase-difference detection pixel 41P.

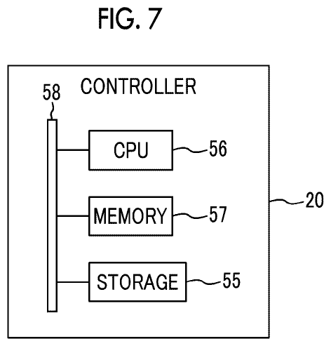

As shown in FIG. 7 as an example, the controller 20 comprises a storage 55, a central processing unit (CPU) 56, and a memory 57. The storage 55, the CPU 56, and the memory 57 are connected to each other through a busline 58. The controller 20 is an example of a “focus control device” and a “computer” according to the present disclosed technology.

The storage 55 is a non-volatile storage device, such as an electrically erasable programmable read-only memory (EEPROM). The storage 55 stores various programs, various types of data associated with the various programs, and the like. It should be noted that, instead of the EEPROM, a ferroelectric random-access memory (FeRAM) or a magnetoresistive random-access memory (MRAM) may be used as the storage 55.

The memory 57 is a work memory for the CPU 56 to execute processing. The CPU 56 loads the program stored in the storage 55 into the memory 57 to execute the loaded processing in accordance with the program. As a result, the CPU 56 controls the respective units of the imaging apparatus 10 in an integrated manner. The CPU 56 is an example of a “processor” according to the present disclosed technology. It should be noted that the memory 57 may be built in the CPU 56.

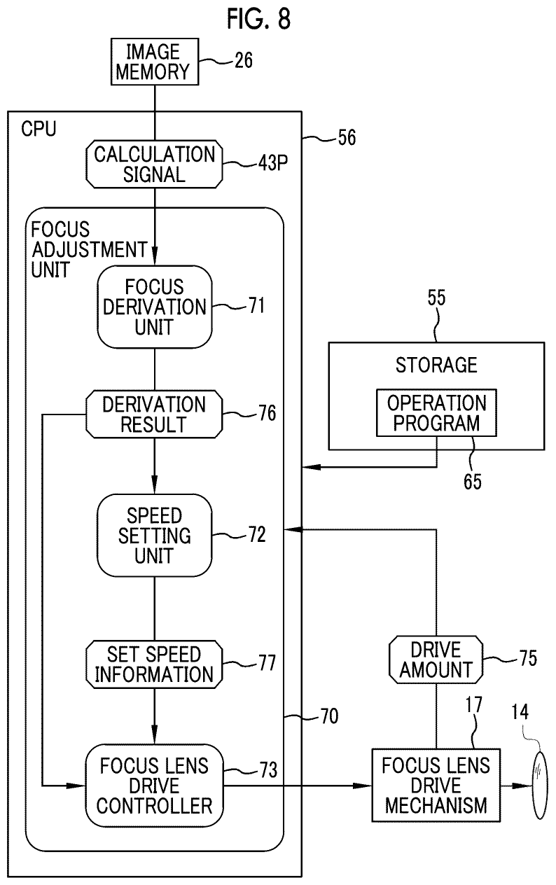

As shown in FIG. 8 as an example, an operation program 65 is stored in the storage 55. The operation program 65 is a program causing the CPU 56 to perform the automatic focus control and the like. That is, the operation program 65 is an example of an “operation program of a focus control device” according to the present disclosed technology.

In a case in which the operation program 65 is started, the CPU 56 functions as a focus adjustment unit 70 in cooperation with the memory 57 and the like. The focus adjustment unit 70 includes a focus derivation unit 71, a speed setting unit 72, and a focus lens drive controller 73. It should be noted that the CPU 56 also functions as various processing units in addition to the focus adjustment unit 70.

A drive amount 75 of the focusing motor is input to the focus adjustment unit 70 from the focus lens drive mechanism 17. The focus adjustment unit 70 derives a position (hereinafter, referred to as a current position) of the focus lens 14 on the optical axis OA from the drive amount 75.

The focus derivation unit 71 reads out the calculation signal 43P from the image memory 26. Specifically, the calculation signal 43P is data in which a plurality of first calculation signals 431P output from the first phase-difference detection pixel 411P are two-dimensionally arranged in the X-direction and the Y-direction following the arrangement of the first phase-difference detection pixels 411P, and data in which a plurality of second calculation signals 432P output from the second phase-difference detection pixel 412P are two-dimensionally arranged in the X-direction and the Y-direction following the arrangement of the second phase-difference detection pixels 412P. Therefore, the calculation signal 43P can be treated as two-dimensional image data.

The focus derivation unit 71 calculates the phase difference α shown in FIG. 6 from the calculation signal 43P of the focus adjustment region. The focus derivation unit 71 derives the estimated focusing position of the focus lens 14 in a case in which the focus lens 14 is located at the current position, based on the phase difference α. The focus derivation unit 71 outputs a derivation result 76 of the estimated focusing position to the speed setting unit 72 and the focus lens drive controller 73. It should be noted that, since a method of deriving the estimated focusing position of the focus lens 14 based on the phase difference α is known, the detailed description thereof is omitted here.

The speed setting unit 72 sets a moving speed V of the focus lens 14 from the current position to the estimated focusing position based on an absolute value |AA| of a difference between the current position of the focus lens 14 derived from the drive amount 75 and the estimated focusing position of the focus lens 14 represented by the derivation result 76 from the focus derivation unit 71. The speed setting unit 72 outputs set speed information 77 including a set moving speed (hereinafter, may be referred to as a set speed) V of the focus lens 14 to the focus lens drive controller 73.

The focus lens drive controller 73 controls the drive of the focus lens drive mechanism 17 and thus the focus lens 14. Specifically, the focus lens drive controller 73 moves the focus lens 14 from the current position to the estimated focusing position at the set speed V via the focus lens drive mechanism 17. Here, the phrase “the focus lens drive controller 73 moves the focus lens 14” strictly means issuing the drive signal from the focus lens drive controller 73 to the driver of the focusing motor of the focus lens drive mechanism 17 to move the focus lens 14 via the focusing motor. In a case in which the current position and the estimated focusing position of the focus lens 14 are the same, the focus lens drive controller 73 does nothing, and the focus lens 14 is not moved.

The focus adjustment unit 70 performs, for each frame, the derivation of the estimated focusing position via the focus derivation unit 71, the setting of the moving speed V of the focus lens 14 via the speed setting unit 72, and the drive control of the focus lens 14 via the focus lens drive controller 73. Therefore, the derivation result 76 of the estimated focusing position obtained by the focus derivation unit 71 is updated for each frame. Therefore, the number of times of derivation of the estimated focusing position per unit time is 1 time/frame.

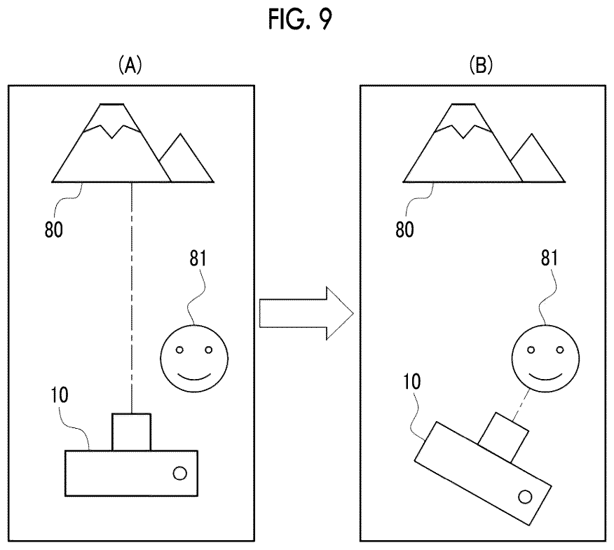

Here, a scene shown in FIG. 9 is considered as an example. That is, (A) shows a case in which the video is captured using a mountain 80 in a distant view as the subject. As shown in (B) from a state shown in (A), in a case in which the subject is switched from the mountain 80 in the distant view to a person 81 in a near view, a subject distance is changed greatly. It should be noted that the subject distance is a distance between the imaging apparatus 10 and a main subject. The main subject is, for example, the subject present in the focus adjustment region. The main subject in a case of (A) is the mountain 80, and the main subject in a case of (B) is the person 81.

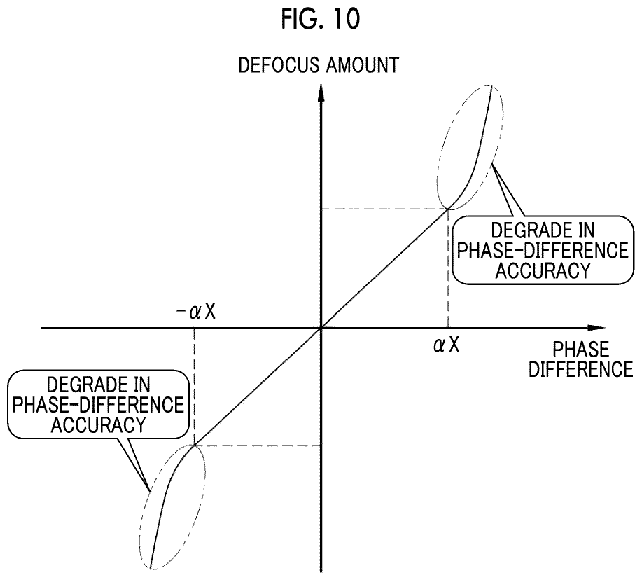

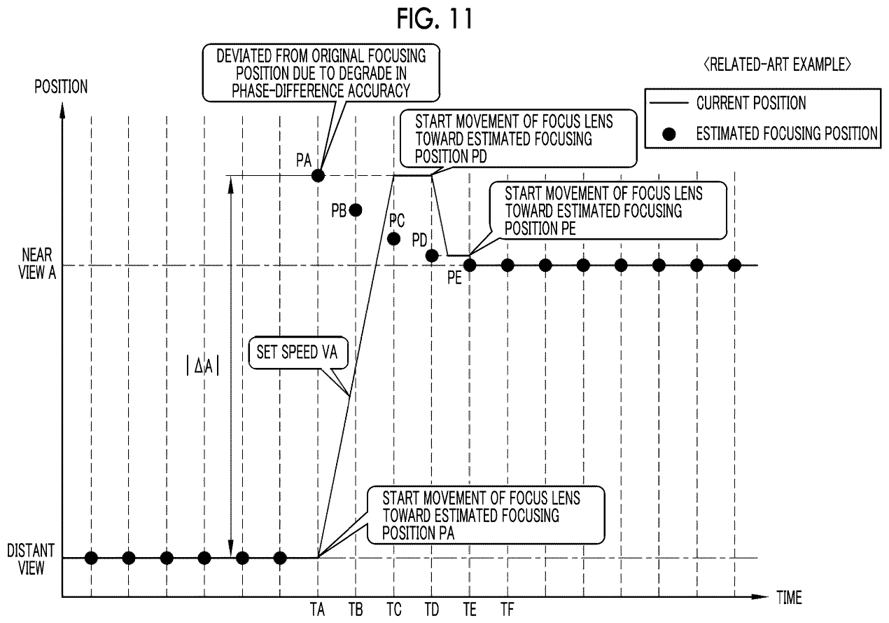

As shown in FIG. 10 as an example, in a relationship between the phase difference α and the defocus amount, a proportional relationship (linearity) is maintained in −αX≤α≤αX, but, the proportional relationship is broken in αX<α and α<−αX, and the phase-difference detection accuracy is degraded. Therefore, in a scene in which the subject distance is changed greatly as shown in FIG. 9, the estimated focusing position deviates from an original focusing position (see FIG. 11). It should be noted that the defocus amount is a difference between the current position of the focus lens 14 and the original focusing position.

FIG. 11 shows transitions of the current position and the estimated focusing position of the focus lens 14 in the related-art example in a case in which the subject is switched from the distant view to a near view A at a time TA. A case in which the subject is switched from the distant view to the near view A is a scene in which the subject distance is changed greatly as shown in FIG. 9, and is a case in which the phase-difference detection accuracy is degraded. Therefore, an estimated focusing position PA at the time TA deviates from the original focusing position of the near view A indicated by a one-dot chain line.

At the time TA, the focus lens drive controller 73 starts the movement of the focus lens 14 toward the estimated focusing position PA at a set speed VA. The focus lens drive controller 73 stops the focus lens 14 at the estimated focusing position PA at a time TC that is two frames after the time TA. The focus lens drive controller 73 causes the current position of the focus lens 14 to stay at the estimated focusing position PA until a time TD. It should be noted that the set speed VA is, for example, the fastest moving speed of the focus lens 14. The term “stop” does not mean that the focus lens 14 is stopped at the specific position permanently, but means that the focus lens 14 is temporarily stopped.

As the absolute value |ΔA| of the difference between the current position of the focus lens 14 and the estimated focusing position is degraded with the movement of the focus lens 14 to the estimated focusing position PA, the phase-difference detection accuracy is restored, and the estimated focusing position gradually converges to the original focusing position. Therefore, at the time TD, an estimated focusing position PD closer to the original focusing position than the estimated focusing position PA is updated. Therefore, at the time TD, the focus lens drive controller 73 starts the movement of the focus lens 14 toward the estimated focusing position PD at the set speed VA. The focus lens drive controller 73 stops the focus lens 14 at the estimated focusing position PD between the time TD and a time TE.

At the time TE, an estimated focusing position PE closer to the original focusing position than the estimated focusing position PD is updated. Therefore, at the time TE, the focus lens drive controller 73 starts the movement of the focus lens 14 toward the estimated focusing position PE at the set speed VA. The focus lens drive controller 73 stops the focus lens 14 at the estimated focusing position PE between the time TE and a time TF. In this way, in a scene in which the subject distance is changed greatly as shown in FIG. 9, the position of the focus lens 14 is unstable due to the deviation of the estimated focusing position from the original focusing position. In a case in which an out-of-focus state in which the position of the focus lens 14 is unstable continues for a long time, the appearance of the captured video is deteriorated.

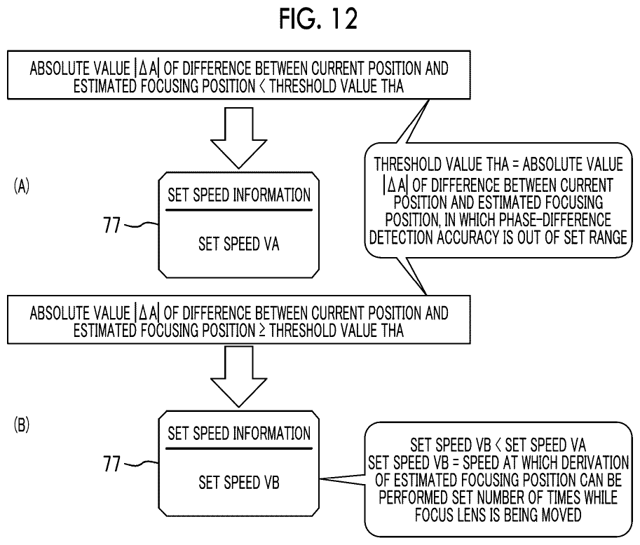

Therefore, in the present disclosed technology, as shown in (A) of FIG. 12 as an example, in a case in which the absolute value |ΔA| of the difference between the current position and the estimated focusing position of the focus lens 14 is less than a threshold value THA, the speed setting unit 72 sets the moving speed of the focus lens 14 to the set speed VA. On the other hand, as shown in (B), in a case in which the absolute value |ΔA| of the difference between the current position and the estimated focusing position of the focus lens 14 is equal to or greater than the threshold value THA, the speed setting unit 72 sets the moving speed of the focus lens 14 to a set speed VB lower than the set speed VA. The threshold value THA is stored in the storage 55. The absolute value |ΔA| of the difference between the current position and the estimated focusing position, in which the phase-difference detection accuracy is out of a set range, is set as the threshold value THA. A case in which “the phase-difference detection accuracy is out of a set range” is a case in which there is a concern that the variation of the position of the focus lens 14 that can be recognized by the user may occur (out-of-focus state continues) due to the change in the subject distance. The threshold value THA is an example of a “first threshold value” according to the present disclosed technology. The set speed VA is an example of a “first speed” according to the present disclosed technology. The set speed VB is an example of a “second speed” according to the present disclosed technology.

The speed setting unit 72 sets the set speed VB to a speed at which the derivation of the estimated focusing position can be performed the set number of times while the focus lens 14 is being moved, based on the absolute value |ΔA| of the difference between the current position and the estimated focusing position of the focus lens 14 and the number of times of derivation of the estimated focusing position per unit time. The set number of times is set to the number of times the estimated focusing position is expected to converge to the original focusing position.

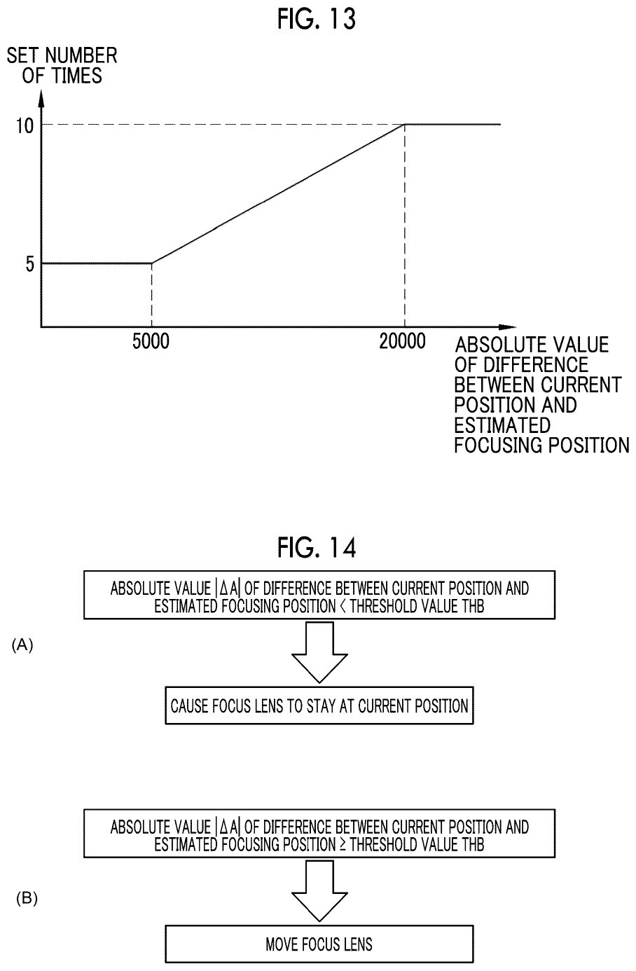

As shown in FIG. 13 as an example, the set number of times of derivation of the estimated focusing position is changed in accordance with the absolute value |ΔA| of the difference between the current position of the focus lens 14 and the estimated focusing position. More specifically, in a case in which the absolute value |ΔA| of the difference between the current position of the focus lens 14 and the estimated focusing position is less than 5000% (focal depth), the set number of times is 5 times. In a case in which the absolute value |ΔA| of the difference between the current position of the focus lens 14 and the estimated focusing position is equal to or greater than 5000% and less than 20000%, the set number of times is gradually increased from 5 times to 10 times. In a case in which the absolute value |ΔA| of the difference between the current position of the focus lens 14 and the estimated focusing position is equal to or greater than 20000%, the set number of times is 10 times.

Further, as shown in (A) of FIG. 14 as an example, in a case in which the absolute value |ΔA| of the difference between the current position of the focus lens 14 and the estimated focusing position is less than a threshold value THB, the focus lens drive controller 73 causes the focus lens 14 to stay at the current position. That is, in a case in which the absolute value |ΔA| of the difference between the current position of the focus lens 14 and the estimated focusing position is less than the threshold value THB, it is considered that the current position of the focus lens 14 and the estimated focusing position are the same as each other. Stated another way, a margin is provided for determining whether or not to move the focus lens 14. On the other hand, in a case in which the absolute value |ΔA| of the difference between the current position of the focus lens 14 and the estimated focusing position is equal to or greater than the threshold value THB, the focus lens drive controller 73 moves the focus lens 14. The absolute value |ΔA| of the difference between the current position of the focus lens 14 and the estimated focusing position, in which the user can recognize the out-of-focus state, is set as the threshold value THB. The threshold value THB is stored in the storage 55. The threshold value THB is an example of a “fourth threshold value” according to the present disclosed technology.

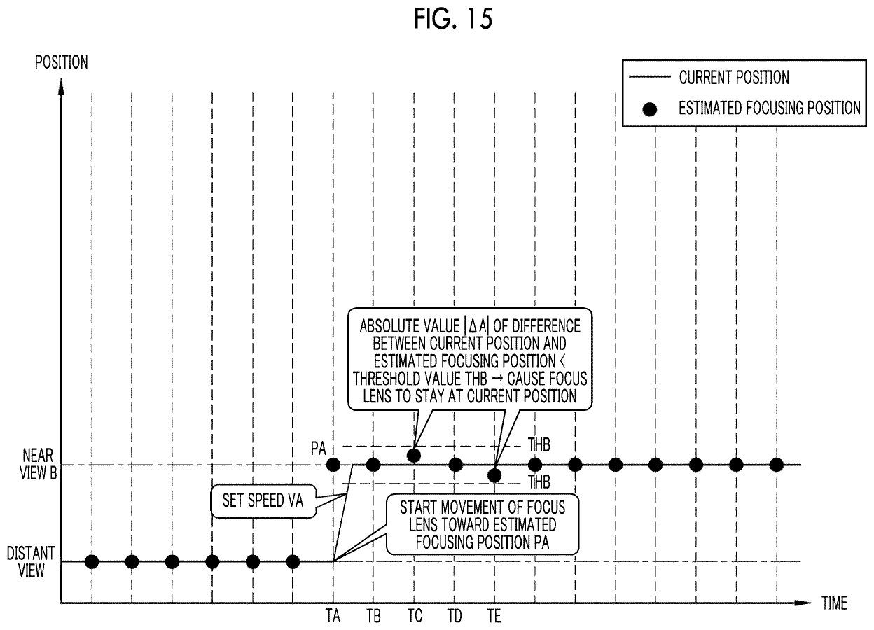

FIG. 15 shows transitions of the current position and the estimated focusing position of the focus lens 14 in a case in which the subject is switched from the distant view to a near view B at the time TA. The near view B is closer to the distant view than the near view A, and a case in which the subject is switched from the distant view to the near view B is a case in which the phase-difference detection accuracy is within the set range. That is, FIG. 15 corresponds to a case in which the absolute value |ΔA| of the difference between the current position of the focus lens 14 and the estimated focusing position is less than the threshold value THA. Therefore, the estimated focusing position PA at the time TA matches the original focusing position of the near view B indicated by a one-dot chain line. It should be noted that the phrase “the estimated focusing position matches the original focusing position” includes not only a case in which the estimated focusing position completely matches the original focusing position but also a case in which an absolute value of the difference between the estimated focusing position and the original focusing position is less than the threshold value THB.

The speed setting unit 72 sets the moving speed of the focus lens 14 to the set speed VA. At the time TA, the focus lens drive controller 73 starts the movement of the focus lens 14 toward the estimated focusing position PA at a set speed VA. The focus lens drive controller 73 stops the focus lens 14 at the estimated focusing position PA between the time TA and a time TB. In this way, in a case in which the phase-difference detection accuracy is within the set range, and the estimated focusing position matches the original focusing position, the focus lens drive controller 73 moves the focus lens 14 to the estimated focusing position at the set speed VA as soon as possible.

At the time TC and the time TE, the estimated focusing position is slightly shifted from the original focusing position. However, since the absolute value |ΔA| of the difference between the current position of the focus lens 14 and the estimated focusing position is less than the threshold value THB, the focus lens drive controller 73 causes the focus lens 14 to stay at the current position.

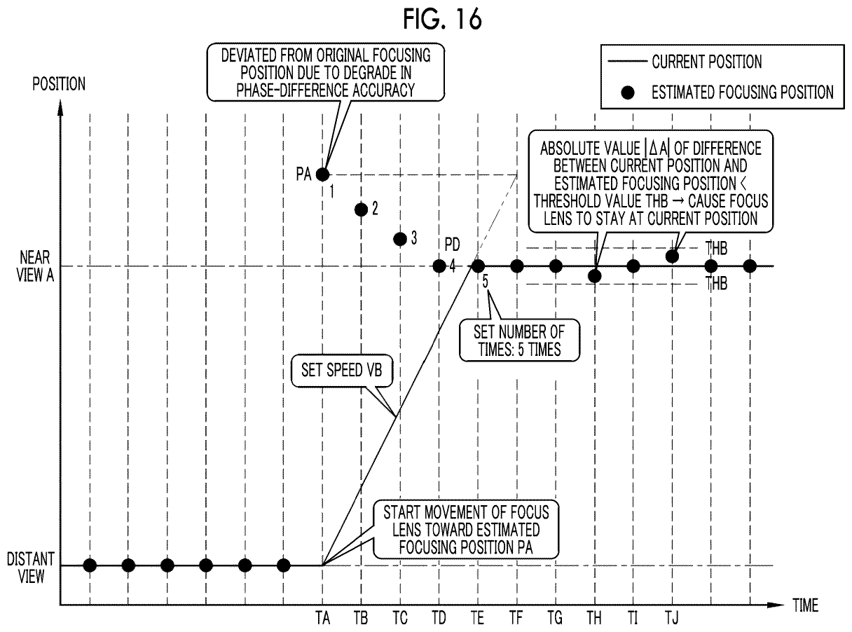

FIG. 16 shows transitions of the current position of the focus lens 14 and the estimated focusing position in a case in which the subject is switched from the distant view to the near view A at the time TA, as in FIG. 11. A case in which the subject is switched from the distant view to the near view A corresponds to a case in which the absolute value |ΔA| of the difference between the current position of the focus lens 14 and the estimated focusing position is equal to or greater than the threshold value THA.

The speed setting unit 72 sets the moving speed of the focus lens 14 to the set speed VB. At the time TA, the focus lens drive controller 73 starts the movement of the focus lens 14 toward the estimated focusing position PA at the set speed VB. Here, the speed setting unit 72 sets the set speed VB to a speed at which the derivation of the estimated focusing position can be performed five times, which is the set number of times, while the focus lens 14 is being moved to the estimated focusing position PA. In this case, five times of the derivation of the estimated focusing position corresponds to the derivation of the estimated focusing positions at the times TA, TB, TC, TD, and TE.

At the time TD, the estimated focusing position converges and is updated to the estimated focusing position PD that matches the original focusing position. Therefore, the focus lens drive controller 73 stops the focus lens 14 at the estimated focusing position PD between the time TD and a time TE. It should be noted that, although it is a very rare case, in a case in which the estimated focusing position does not converge to the original focusing position in the derivation of the set number of times, and the absolute value |ΔA| of the difference between the current position of the focus lens 14 and a newly updated estimated focusing position is equal to or greater than the threshold value THB after the focus lens 14 is stopped, the focus lens drive controller 73 moves the focus lens 14 to the newly updated estimated focusing position.

As in cases of the time TC and the time TE in FIG. 15, at times TH and TJ, the estimated focusing position is slightly shifted from the original focusing position. However, since the absolute value |ΔA| of the difference between the current position of the focus lens 14 and the estimated focusing position is less than the threshold value THB, the focus lens drive controller 73 causes the focus lens 14 to stay at the current position.

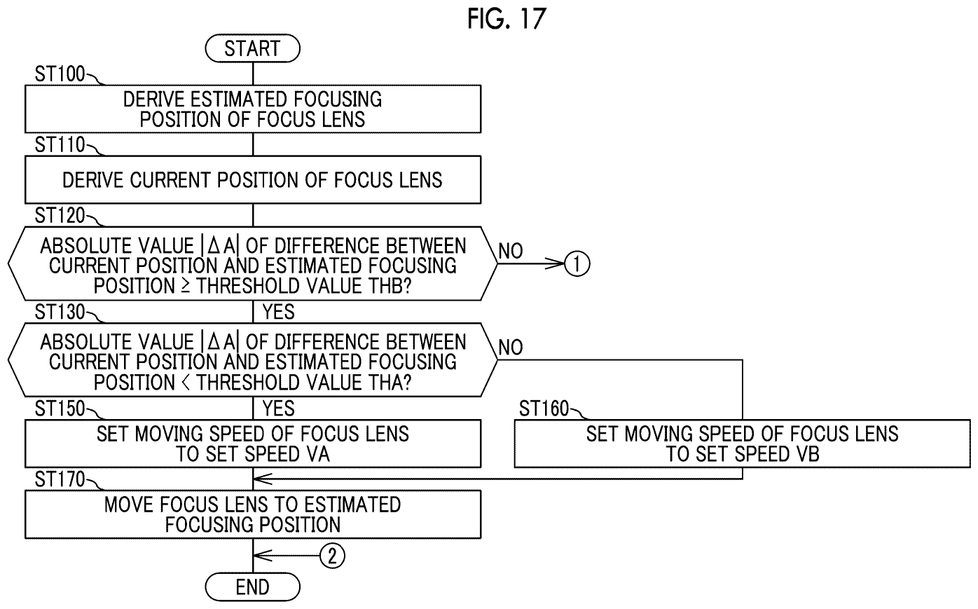

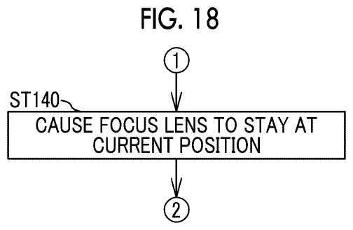

Next, the operation and effects of the above-described configuration will be described with reference to the flowcharts shown in FIGS. 17 and 18 as an example. As shown in FIG. 8, the CPU 56 starts the operation program 65 to function as the focus adjustment unit 70. The focus adjustment unit 70 includes the focus derivation unit 71, the speed setting unit 72, and the focus lens drive controller 73.

In a case in which the release button is fully pressed in the video capturing mode, and the instruction reception unit 32 receives the instruction to start the capturing of the video, the accumulation operation of the signal charge in accordance with the subject light is performed in the imaging element 12 under the control of the controller 20. Subsequently, the readout operation of the image signal 43 in accordance with the signal charge is performed. The image signal 43 is stored in the image memory 26 via the image input controller 25. The image signal 43 is subjected to various types of image processing by the image processing unit 27 and then written back to the image memory 26.

The calculation signal 43P is read out from the image memory 26 to the focus derivation unit 71. Then, in the focus derivation unit 71, the phase difference α is calculated from the calculation signal 43P of the focus adjustment region, and the estimated focusing position of the focus lens 14 is derived based on the phase difference α (step ST100). The derivation result 76 of the estimated focusing position is output from the focus derivation unit 71 to the speed setting unit 72 and the focus lens drive controller 73. In addition, in the focus adjustment unit 70, the current position of the focus lens 14 on the optical axis OA is derived based on the drive amount 75 of the focusing motor from the focus lens drive mechanism 17 (step ST110).

In a case in which the absolute value |ΔA| of the difference between the current position of the focus lens 14 and the estimated focusing position is equal to or greater than the threshold value THB (YES in step ST120), the processing proceeds to step ST130. On the other hand, in a case in which the absolute value |ΔA| of the difference between the current position of the focus lens 14 and the estimated focusing position is less than the threshold value THB (NO in step ST120), the processing proceeds to step ST140 in FIG. 18. In step ST140, as shown in (A) of FIG. 14, the focus lens drive controller 73 causes the focus lens 14 to stay at the current position, and the processing ends.

In step ST130, the absolute value |ΔA| of the difference between the current position of the focus lens 14 and the estimated focusing position is compared with the threshold value THA. In a case in which the absolute value |ΔA| of the difference between the current position of the focus lens 14 and the estimated focusing position is less than the threshold value THA, as shown in (A) of FIG. 12, the moving speed of the focus lens 14 is set to the set speed VA in the speed setting unit 72 (step ST150). On the other hand, in a case in which the absolute value |ΔA| of the difference between the current position of the focus lens 14 and the estimated focusing position is equal to or greater than the threshold value THA, as shown in (B) of FIG. 12, the moving speed of the focus lens 14 is set to the set speed VB in the speed setting unit 72 (step ST160). In this case, the set number of times corresponding to the absolute value |ΔA| of the difference between the current position of the focus lens 14 and the estimated focusing position is decided on in the speed setting unit 72 with reference to the graph shown in FIG. 13. Then, the set speed VB is set to the speed at which the derivation of the estimated focusing position can be performed the set number of times while the focus lens 14 is being moved. Thereafter, the set speed information 77 is output from the speed setting unit 72 to the focus lens drive controller 73.

The focus lens 14 is moved to the estimated focusing position at the set speed VA or VB via the focus lens drive mechanism 17 under the control of the focus lens drive controller 73 (step ST170). The processing of ST100 to ST170 continues until the release button is fully pressed again, and the instruction reception unit 32 receives an instruction to end the capturing of the video.

As described above, the imaging apparatus 10 comprises the controller 20 that is a focus control device for performing focus control of the focus lens 14 based on the output from the phase-difference detection pixel 41P. The CPU 56 of the controller 20 functions as the focus adjustment unit 70. The focus adjustment unit 70 includes the focus derivation unit 71, the speed setting unit 72, and the focus lens drive controller 73. The focus adjustment unit 70 acquires the current position of the focus lens 14 on the optical axis OA by deriving the current position of the focus lens 14 based on the drive amount 75 of the focusing motor from the focus lens drive mechanism 17. The focus derivation unit 71 acquires the estimated focusing position of the focus lens 14 in a case in which the focus lens 14 is located at the current position by deriving the estimated focusing position of the focus lens 14. In a case in which the absolute value |ΔA| of the difference between the current position of the focus lens 14 and the estimated focusing position is less than the threshold value THA, the speed setting unit 72 sets the moving speed of the focus lens 14 to the set speed VA. The focus lens drive controller 73 moves the focus lens 14 at the set speed VA. On the other hand, in a case in which the absolute value |ΔA| of the difference between the current position of the focus lens 14 and the estimated focusing position is equal to or greater than the threshold value THA, the speed setting unit 72 sets the moving speed of the focus lens 14 to a set speed VB lower than the set speed VA. The focus lens drive controller 73 moves the focus lens 14 at the set speed VB. Therefore, it is possible to suppress the variation of the position of the focus lens 14 that occurs in a case in which the subject distance is greatly changed.

As shown in FIG. 12, the absolute value |ΔA| of the difference between the current position of the focus lens 14 and the estimated focusing position, in which the phase-difference detection accuracy is out of the set range, is set as the threshold value THA. Therefore, it is possible to effectively suppress the variation of the position of the focus lens 14 that occurs in a case in which the subject distance is greatly changed as the phase-difference detection accuracy is out of the set range.

As shown in FIG. 12, the speed setting unit 72 sets the set speed VB to the speed at which the derivation of the estimated focusing position can be performed the set number of times while the focus lens 14 is being moved, based on the absolute value |ΔA| of the difference between the current position of the focus lens 14 and the estimated focusing position and the number of times of derivation of the estimated focusing position per unit time. The estimated focusing position is restored in the phase-difference detection accuracy each time the derivation is repeated, and gradually converges to the original focusing position. Therefore, in a case in which the set speed VB is set to the speed at which the derivation of the estimated focusing position can be performed the set number of times while the focus lens 14 is being moved, the focus lens 14 can be stopped at the original focusing position without passing beyond the original focusing position.

As shown in FIG. 13, the set number of times is changed in accordance with the absolute value |ΔA| of the difference between the current position of the focus lens 14 and the estimated focusing position. Therefore, the set speed VB suitable for the absolute value |ΔA| of the difference between the current position of the focus lens 14 and the estimated focusing position can be set.

As shown in FIG. 14, in a case in which the absolute value |ΔA| of the difference between the current position of the focus lens 14 and the estimated focusing position is less than the threshold value THB, the focus lens drive controller 73 causes the focus lens 14 to stay at the current position. On the other hand, in a case in which the absolute value |ΔA| of the difference between the current position of the focus lens 14 and the estimated focusing position is equal to or greater than the threshold value THB, the focus lens drive controller 73 moves the focus lens 14. Therefore, even in a case in which there is a fine difference between the current position of the focus lens 14 and the estimated focusing position that the user cannot recognize the out-of-focus state, it is possible to suppress the focus lens 14 from being moved each time and to prevent the movement of the focus lens 14 from being repeated frequently.

### Second Embodiment

In the first embodiment, an example has been described in which the derivation result 76 of the estimated focusing position obtained by the focus derivation unit 71 is updated for each frame. However, depending on a model of the imaging apparatus 10, the estimated focusing position may not be updatable while the focus lens 14 is being moved. Therefore, in the second embodiment, a method of determining whether or not to stop the focus lens 14 in the model in which the estimated focusing position cannot be updated while the focus lens 14 is being moved will be described.

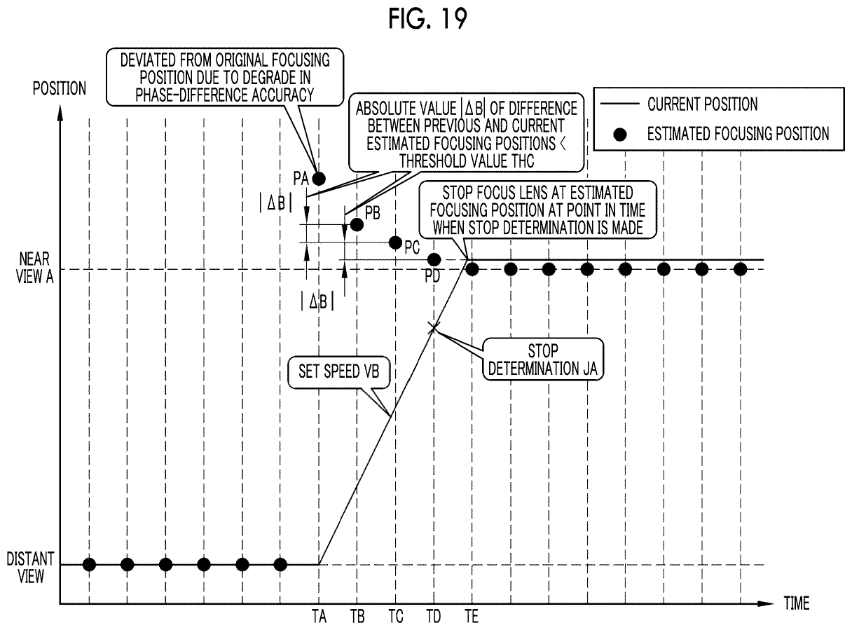

FIG. 19 shows transitions of the current position and the estimated focusing position of the focus lens 14 in a case in which the subject is switched from the distant view to the near view A at the time TA, as in FIGS. 11 and 16. The speed setting unit 72 sets the moving speed of the focus lens 14 to the set speed VB. At the time TA, the focus lens drive controller 73 starts the movement of the focus lens 14 at the set speed VB. In this case, the focus lens drive controller 73 moves the focus lens 14 toward a drive end of the focus lens 14 on the near view side instead of the estimated focusing position PA. As in the first embodiment, the set speed VB is set to a speed at which the derivation of the estimated focusing position can be performed the set number of times by the speed setting unit 72 while the focus lens 14 is being moved. In addition, the set number of times is changed in accordance with the absolute value |ΔA| of the difference between the current position of the focus lens 14 and the estimated focusing position.

The focus lens drive controller 73 starts calculation of an absolute value |ΔB| of the difference between the previous and current estimated focusing positions (in the previous and current frames) at the same time as the start of the movement of the focus lens 14. The absolute value |ΔB| of the difference between the previous estimated focusing position and the current estimated focusing position is, specifically, an absolute value |ΔB| of a difference between the estimated focusing position PA at the time TA and the estimated focusing position PB at the time TB, an absolute value |ΔB| of a difference between the estimated focusing position PB at the time TB and the estimated focusing position PC at the time TC, an absolute value |ΔB| of a difference between the estimated focusing position PC at the time TC and the estimated focusing position PD at the time TD, or the like. The former estimated focusing position corresponds to the previous estimated focusing position (in the previous frame), and the latter estimated focusing position corresponds to the current estimated focusing position (in the current frame).

The focus lens drive controller 73 compares the absolute value |ΔB| of the difference between the previous estimated focusing position and the current estimated focusing position with a threshold value THC. Then, in a case in which the absolute value |ΔB| of the difference between the previous estimated focusing position and the current estimated focusing position is less than the threshold value THC for two consecutive frames, the focus lens drive controller 73 makes a stop determination JA. The threshold value THC is stored in the storage 55. The threshold value THC is an example of a “third threshold value” according to the present disclosed technology. FIG. 19 shows a case in which both the absolute value |ΔB| of the difference between the estimated focusing position PB at the time TB and the estimated focusing position PC at the time TC and the absolute value |ΔB| of the difference between the estimated focusing position PC at the time TC and the estimated focusing position PD at the time TD are less than the threshold value THC, and the stop determination JA is made at the time TD.

The focus lens drive controller 73 stops the focus lens 14 at the estimated focusing position at which the stop determination JA is made. FIG. 19 shows a case in which the focus lens 14 is stopped at the estimated focusing position PD at the time TD at which the stop determination JA is made, between the time TD and the time TE.

As shown in the drawing, in a case in which the absolute value |ΔA| of the difference between the current position of the focus lens 14 and the estimated focusing position is less than the threshold value THB after the focus lens 14 is stopped by the stop determination JA, the focus lens drive controller 73 causes the focus lens 14 to stay at the current position. In a case in which the absolute value |ΔA| of the difference between the current position of the focus lens 14 and the estimated focusing position is equal to or greater than the threshold value THB and less than the threshold value THA after the focus lens 14 is stopped by the stop determination JA, the focus lens drive controller 73 moves the focus lens 14 at the set speed VA. In addition, although it is a very rare case, in a case in which the absolute value |ΔA| of the difference between the current position of the focus lens 14 and the estimated focusing position is equal to or greater than the threshold value THA after the focus lens 14 is stopped by the stop determination JA, the focus lens drive controller 73 moves the focus lens 14 at the set speed VB.

It should be noted that the condition for making the stop determination JA is not limited to the above-described case in which the absolute value JAB| of the difference between the previous estimated focusing position and the current estimated focusing position is less than the threshold value THC for the two consecutive frames. The condition for making the stop determination JA may be a case in which the absolute value |ΔB| of the difference between the previous estimated focusing position and the current estimated focusing position is less than the threshold value THC for three or four consecutive frames, or may be a case in which the absolute value |ΔB| of the difference between the previous estimated focusing position and the current estimated focusing position is less than the threshold value THC for just one frame.

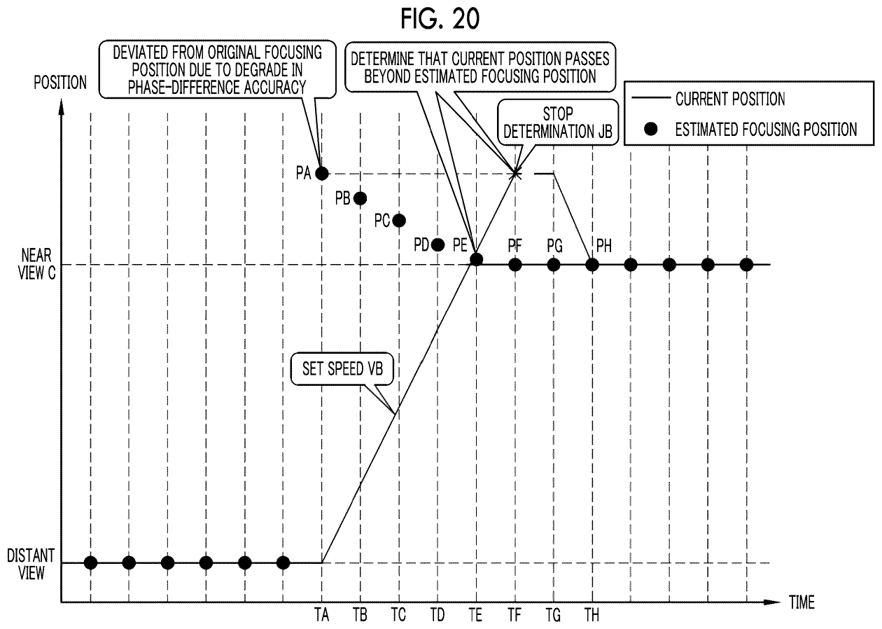

FIG. 20 shows transitions of the current position and the estimated focusing position of the focus lens 14 in a case in which the subject is switched from the distant view to a near view C at the time TA. A case in which the subject is switched from the distant view to the near view C is a scene in which the subject distance is changed greatly, as in a case in which the subject is switched from the distant view to the near view A, and is a case in which the phase-difference detection accuracy is degraded. Therefore, the estimated focusing position PA at the time TA deviates from the original focusing position of the near view C indicated by a one-dot chain line.

The speed setting unit 72 sets the moving speed of the focus lens 14 to the set speed VB. At the time TA, the focus lens drive controller 73 starts the movement of the focus lens 14 toward the drive end of the focus lens 14 on the near view side at the set speed VB. As in the first embodiment, the set speed VB is set to a speed at which the derivation of the estimated focusing position can be performed the set number of times by the speed setting unit 72 while the focus lens 14 is being moved. In addition, the set number of times is changed in accordance with the absolute value |ΔA| of the difference between the current position of the focus lens 14 and the estimated focusing position.

The focus lens drive controller 73 starts the movement of the focus lens 14 and simultaneously starts monitoring whether or not the current position of the focus lens 14 passes beyond the estimated focusing position. Whether or not the current position of the focus lens 14 passes beyond the estimated focusing position can be determined by whether or not a sign of the difference between the current position of the focus lens 14 and the estimated focusing position is reversed between the previous time and the current time (previous frame and current frame). In order to make such a determination, the focus lens drive controller 73 calculates a difference between the current position and the estimated focusing position of the focus lens 14 in a state in which the sign is known.

In a case in which it is determined that the current position of the focus lens 14 passes beyond the estimated focusing position for two consecutive frames, the focus lens drive controller 73 makes a stop determination JB and stops the focus lens 14. FIG. 20 shows a case in which it is determined that the current position of the focus lens 14 passes beyond the estimated focusing position at the time TE and the time TF, the stop determination JB is made at the time TF, and the focus lens 14 is stopped at the estimated focusing position PA.

The focus lens drive controller 73 causes the focus lens 14 to stay at the estimated focusing position PA until a time TG. At the time TG, the focus lens drive controller 73 starts the movement of the focus lens 14 toward the estimated focusing position PG at the set speed VA. At the time TH, the focus lens drive controller 73 stops the focus lens 14 at the estimated focusing position PG.

As shown in the drawing, in a case in which the absolute value |ΔA| of the difference between the current position of the focus lens 14 and the estimated focusing position is less than the threshold value THB after the focus lens 14 is stopped by the stop determination JB, the focus lens drive controller 73 causes the focus lens 14 to stay at the current position. In a case in which the absolute value |ΔA| of the difference between the current position of the focus lens 14 and the estimated focusing position is equal to or greater than the threshold value THB and less than the threshold value THA after the focus lens 14 is stopped by the stop determination JB, the focus lens drive controller 73 moves the focus lens 14 at the set speed VA. In addition, although it is a very rare case, in a case in which the absolute value |ΔA| of the difference between the current position of the focus lens 14 and the estimated focusing position is equal to or greater than the threshold value THA after the focus lens 14 is stopped by the stop determination JB, the focus lens drive controller 73 moves the focus lens 14 at the set speed VB.

It should be noted that the condition for making the stop determination JB is not limited to the above-described case in which it is determined that the current position of the focus lens 14 passes beyond the estimated focusing position for two consecutive frames. The condition for making the stop determination JB may be a case in which it is determined that the current position of the focus lens 14 passes beyond the estimated focusing position for three or four consecutive frames, or may be a case in which it is determined that the current position of the focus lens 14 passes beyond the estimated focusing position only for one frame.

As described above, in the second embodiment, as shown in FIG. 19, the speed setting unit 72 derives the estimated focusing position a plurality of times while the focus lens 14 is being moved at the set speed VB. In a case in which the absolute value |ΔB| of the difference between the previous estimated focusing position and the current estimated focusing position is less than the threshold value THC, the focus lens drive controller 73 stops the movement of the focus lens 14. Further, as shown in FIG. 20, in a case in which the focus lens drive controller 73 determines that the current position of the focus lens 14 passes beyond the estimated focusing position while the focus lens 14 is being moved at the set speed VB, the focus lens drive controller 73 stops the movement of the focus lens 14. Therefore, even in a case of the model in which the estimated focusing position cannot updated while the focus lens 14 is being moved, it is possible to suppress the variation of the position of the focus lens 14 that occurs in a case in which the subject distance is greatly changed.

Further, in the second embodiment, as shown in FIG. 20, in a case in which the sign of the difference between the current position and the estimated focusing position of the focus lens 14 is reversed, the focus lens drive controller 73 determines that the current position of the focus lens 14 passes beyond the estimated focusing position. Therefore, in a case in which it is monitored whether or not the sign of the difference between the current position of the focus lens 14 and the estimated focusing position is reversed, it is possible to easily determine that the current position of the focus lens 14 passes beyond the estimated focusing position.

In the second embodiment, in a case in which the set speed VB is set to a speed at which the derivation of the estimated focusing position is performed the set number of times while the focus lens 14 is being moved, and the set number of times is changed in accordance with the absolute value |ΔA| of the difference between the current position and the estimated focusing position of the focus lens 14, the following effects can be obtained. That is, in a case in which the set number of times is set to be small and the set speed VB is increased even though the absolute value |ΔA| of the difference between the current position of the focus lens 14 and the estimated focusing position is large, the current position of the focus lens 14 passes beyond the estimated focusing position before the estimated focusing position converges to the original focusing position. As a result, the focus lens 14 cannot be stopped by the stop determination JA, and thus the focus lens 14 has to be stopped by the stop determination JB. In a case in which the focus lens 14 is stopped by the stop determination JB, the position of the focus lens 14 varies slightly as can be seen in FIG. 20. Therefore, it is desired to avoid a situation in which the focus lens 14 is stopped by the stop determination JB, as long as possible. Therefore, in a case in which the absolute value |ΔA| of the difference between the current position of the focus lens 14 and the estimated focusing position is large, the set number of times is set to be large in accordance with the absolute value |ΔA|, the set speed VB is set to be low, and the possibility that the focus lens 14 is stopped by the stop determination JA is increased.

The set speed VB may be set to be higher in a case in which the estimated focusing position can be updated while the focus lens 14 is being moved as in the first embodiment than in a case in which the estimated focusing position cannot be updated while the focus lens 14 is being moved as in the second embodiment. The reason is that, in the first embodiment, in a case in which the estimated focusing position can be derived even once during the movement of the focus lens 14, the focus lens 14 can be stopped at the estimated focusing position closer to the original focusing position.

### Third Embodiment

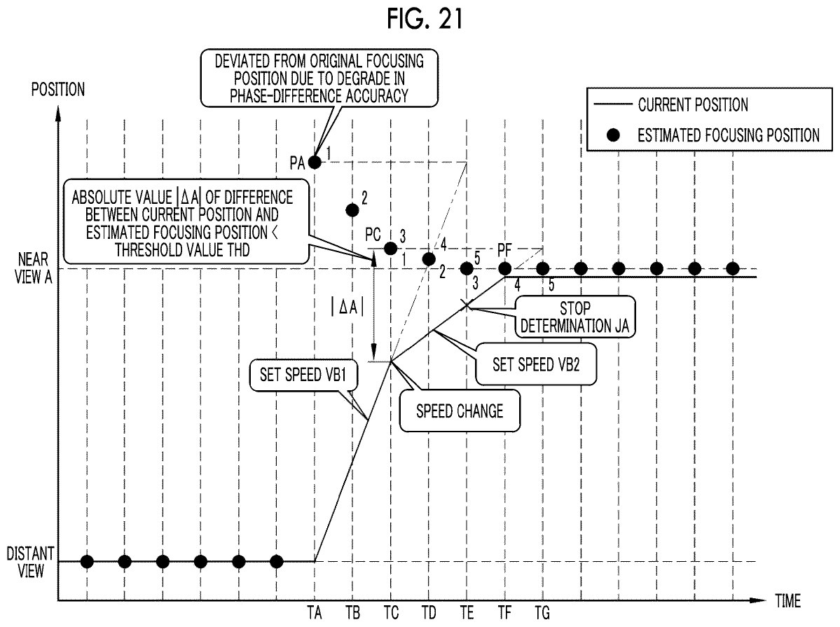

As shown in FIG. 21 as an example, in the third embodiment, the moving speed of the focus lens 14 is changed based on the estimated focusing position in a case in which the absolute value |ΔA| of the difference between the current position of the focus lens 14 and the estimated focusing position is less than a threshold value THD. It should be noted that, in FIG. 21, as in the second embodiment, it is assumed that the imaging apparatus 10 cannot update the estimated focusing position while the focus lens 14 is being moved.

FIG. 21 shows transitions of the current position and the estimated focusing position of the focus lens 14 in a case in which the subject is switched from the distant view to the near view A at the time TA, as in FIGS. 11 and 16. The speed setting unit 72 sets the moving speed of the focus lens 14 to a set speed VB1. At the time TA, the focus lens drive controller 73 starts the movement of the focus lens 14 toward the estimated focusing position PA at the set speed VB1. Here, the speed setting unit 72 sets the set speed VB1 to a speed at which the derivation of the estimated focusing position can be performed five times, which is the set number of times, while the focus lens 14 is being moved to the estimated focusing position PA. In this case, five times of the derivation of the estimated focusing position corresponds to the derivation of the estimated focusing positions at the times TA, TB, TC, TD, and TE.

The speed setting unit 72 starts the comparison between the absolute value |ΔA| of the difference between the current position and the estimated focusing position of the focus lens 14 and the threshold value THD at the same time as the start of the movement of the focus lens 14. In a case in which the absolute value |ΔA| of the difference between the current position and the estimated focusing position of the focus lens 14 is less than the threshold value THD, the speed setting unit 72 changes (resets) the moving speed of the focus lens 14 based on the estimated focusing position in a case in which the absolute value |ΔA| of the difference between the current position and the estimated focusing position of the focus lens 14 is less than the threshold value THD. The threshold value THD is stored in the storage 55. The threshold value THD is an example of a “second threshold value” according to the present disclosed technology.

FIG. 21 shows a case in which the absolute value |ΔA| of the difference between the current position and the estimated focusing position of the focus lens 14 is less than the threshold value THD at the time TC. In addition, a case is shown in which the moving speed of the focus lens 14 is changed to a set speed VB2 by the speed setting unit 72 based on the estimated focusing position PC at the time TC. Here, the speed setting unit 72 sets the set speed VB2 to a speed at which the derivation of the estimated focusing position can be performed five times, which is the set number of times, while the focus lens 14 is being moved to the estimated focusing position PC. In this case, five times of the derivation of the estimated focusing position corresponds to the derivation of the estimated focusing positions at the times TC, TD, TE, TF, and TG.

At the time TC, the focus lens drive controller 73 starts the movement of the focus lens 14 toward the estimated focusing position PC at the changed set speed VB2. Then, the stop determination JA at the time TE stops the focus lens 14 at the estimated focusing position PF at the time TF.

As described above, in the third embodiment, in a case in which the absolute value |4A| of the difference between the current position and the estimated focusing position of the focus lens 14 is less than the threshold value THD while the focus lens 14 is moved at the set speed VB1, the speed setting unit 72 changes the moving speed of the focus lens 14 based on the estimated focusing position in a case in which the absolute value |ΔA| of the difference between the current position and the estimated focusing position of the focus lens 14 is less than the threshold value THD. Therefore, in a case in which the absolute value (ΔA| of the difference between the current position and the estimated focusing position of the focus lens 14 is a value requiring, for example, the set number of times of 10 times, the following measures can be taken. That is, the current position of the focus lens 14 is brought closer to the estimated focusing position in a short time by setting the set speed VB1 corresponding to the set number of times of 5 times, which is higher than the set speed corresponding to the set number of times of 10 times. Then, in a case in which the current position of the focus lens 14 is brought closer to the estimated focusing position (in a case in which the absolute value |ΔA| of the difference between the current position and the estimated focusing position of the focus lens 14 is less than the threshold value THD), the set speed is decreased to the set speed VB2, and the focus lens 14 is stopped in the stop determination JA. In this case, the current position of the focus lens 14 can be made to match the original focusing position in a shorter time than in a case in which the focus lens 14 is moved at the set speed corresponding to the set number of times of 10 times.

In each of the above-described embodiments, a case has been described in which the scene is switched from the distant view to the near view, but the present invention is not limited to this. On the contrary, the present disclosed technology can also be applied to a case in which the scene is switched from the near view to the distant view. In addition, in each of the above-described embodiments, a case of the video capturing has been described as an example, but the present disclosure is not limited to this. The present disclosed technology may be applied in a case of displaying the live view image before the still image capturing or the video capturing.

The imaging apparatus according to the present disclosed technology is not limited to the above-described mirrorless single-lens digital camera, and may be a compact digital camera, a video camera, a surveillance camera, a smartphone, or a tablet terminal.

In each of the above-described embodiments, for example, as a hardware structure of processing units that execute various types of processing, such as the image processing unit 27, the display controller 30, the instruction reception unit 32, the focus adjustment unit 70, the focus derivation unit 71, the speed setting unit 72, and the focus lens drive controller 73, various processors shown below can be used. The various processors include, for example, the CPU 56 which is a general-purpose processor that executes software (operation program 65) to function as various processing units, a programmable logic device (PLD), such as a field programmable gate array (FPGA), which is a processor of which a circuit configuration can be changed after manufacture, and/or a dedicated electric circuit, such as an application specific integrated circuit (ASIC), which is a processor of which a dedicated circuit configuration is designed to execute specific processing.

One processing unit may be configured by one of these various processors, or may be configured by a combination of two or more processors of the same type or different types (for example, a combination of a plurality of FPGAs and/or a combination of a CPU and an FPGA). A plurality of the processing units may be configured by one processor.

As an example in which the plurality of processing units are configured by one processor, first, as represented by a computer, such as a client and a server, there is a form in which one processor is configured by a combination of one or more CPUs and software, and the processor functions as the plurality of processing units. Second, there is a form in which a processor that implements the functions of the entire system including the plurality of processing units with one integrated circuit (IC) chip is used, as represented by a system on a chip (SoC) or the like. In this manner, as the hardware structure, the various processing units are configured by using one or more of the various processors described above.

Further, more specifically, an electric circuit (circuitry), in which circuit elements such as semiconductor elements are combined, can be used as the hardware structure of the various processors.

The technologies according to the following supplementary notes can be understood based on the above description.

### Supplementary Note 1

A focus control device comprising: a processor, in which the processor is configured to: acquire a current position of a focus lens and an estimated focusing position of the focus lens derived in a case in which the focus lens is located at the current position; move the focus lens at a first speed in a case in which an absolute value of a difference between the current position and the estimated focusing position is less than a first threshold value; and move the focus lens at a second speed lower than the first speed in a case in which the absolute value of the difference between the current position and the estimated focusing position is equal to or greater than the first threshold value.

### Supplementary Note 2

The focus control device according to supplementary note 1, in which an absolute value of a difference between the current position and the estimated focusing position, in which phase-difference detection accuracy is out of a set range, is set as the first threshold value.

### Supplementary Note 3

The focus control device according to supplementary note 1 or 2, in which the processor is configured to: set the second speed to a speed at which derivation of the estimated focusing position is able to be performed a set number of times while the focus lens is being moved, based on the absolute value of the difference between the current position and the estimated focusing position and the number of times of derivation of the estimated focusing position per unit time.

### Supplementary Note 4

The focus control device according to supplementary note 3, in which the set number of times is changed in accordance with the absolute value of the difference between the current position and the estimated focusing position.

### Supplementary Note 5

The focus control device according to any one of supplementary notes 1 to 4, in which the processor is configured to: change a moving speed of the focus lens based on the estimated focusing position in a case in which the absolute value of the difference between the current position and the estimated focusing position is less than a second threshold value, in a case in which the absolute value of the difference between the current position and the estimated focusing position is less than the second threshold value while the focus lens is being moved at the second speed.

### Supplementary Note 6

The focus control device according to any one of supplementary notes 1 to 5, in which the processor is configured to: derive the estimated focusing position a plurality of times while the focus lens is being moved at the second speed; and stop movement of the focus lens in a case in which an absolute value of a difference between a previous estimated focusing position and a current estimated focusing position is less than a third threshold value.

### Supplementary Note 7

The focus control device according to any one of supplementary notes 1 to 6, in which the processor is configured to: stop movement of the focus lens in a case in which it is determined that the current position passes beyond the estimated focusing position while the focus lens is being moved at the second speed.

### Supplementary Note 8

The focus control device according to supplementary note 7, in which the processor is configured to: determine that the current position passes beyond the estimated focusing position in a case in which a sign of the difference between the current position and the estimated focusing position is reversed.

### Supplementary Note 9

The focus control device according to any one of supplementary notes 1 to 8, in which the processor is configured to: cause the focus lens to stay at the current position in a case in which the absolute value of the difference between the current position and the estimated focusing position is less than a fourth threshold value; and move the focus lens in a case in which the absolute value of the difference between the current position and the estimated focusing position is equal to or greater than the fourth threshold value.

### Supplementary Note 10

An imaging apparatus comprising: the focus control device according to any one of supplementary notes 1 to 9.

The present disclosed technology can also be combined with various embodiments and/or various modification examples described above, as appropriate. In addition, it goes without saying that the present disclosure is not limited to each of the embodiments described above, various configurations can be adopted as long as the configuration does not deviate from the gist. Further, the present disclosed technology includes, in addition to the program, a storage medium that stores the program in a non-transitory manner.

The above-described contents and the above-shown contents are the detailed description of the parts according to the present disclosed technology, and are merely an example of the present disclosed technology. For example, the above description of the configuration, the function, the operation, and the effect are the description of examples of the configuration, the function, the operation, and the effect of the parts relating to the present disclosed technology. Therefore, it goes without saying that unnecessary parts may be deleted, new elements may be added, or replacements may be made with respect to the contents described and shown above within a range that does not deviate from the gist of the present disclosed technology. In addition, in order to avoid complications and facilitate understanding the parts according to the present disclosed technology, in the above-described contents and the above-shown contents, the description of technical general knowledge and the like that do not particularly require description for enabling the implementation of the present disclosed technology are omitted.

In the present specification, “A and/or B” is synonymous with “at least one of A or B”. That is, “A and/or B” may mean only A, only B, or a combination of A and B. In addition, in the present specification, also in a case in which three or more matters are expressed in association by “and/or”, the same concept as “A and/or B” is applied.

All of the documents, the patent applications, and the technical standards described in the present specification are incorporated herein by reference to the same extent as in a case in which each of the documents, patent applications, and technical standards is specifically and individually described by being incorporated by reference.

What is claimed is:

1. A focus control device comprising:
a processor,
wherein the processor is configured to:
acquire a current position of a focus lens and an estimated focusing position of the focus lens derived in a case in which the focus lens is located at the current position;
move the focus lens at a first speed in a case in which an absolute value of a difference between the current position and the estimated focusing position is less than a first threshold value; and
move the focus lens at a second speed lower than the first speed in a case in which the absolute value of the difference between the current position and the estimated focusing position is equal to or greater than the first threshold value.

2. The focus control device according to claim 1,
wherein an absolute value of a difference between the current position and the estimated focusing position, in which phase-difference detection accuracy is out of a set range, is set as the first threshold value.

3. The focus control device according to claim 1,
wherein the processor is configured to:
set the second speed to a speed at which derivation of the estimated focusing position is able to be performed a set number of times while the focus lens is being moved, based on the absolute value of the difference between the current position and the estimated focusing position and the number of times of derivation of the estimated focusing position per unit time.

4. The focus control device according to claim 3,
wherein the set number of times is changed in accordance with the absolute value of the difference between the current position and the estimated focusing position.

5. The focus control device according to claim 1,
wherein the processor is configured to:
change a moving speed of the focus lens based on the estimated focusing position in a case in which the absolute value of the difference between the current position and the estimated focusing position is less than a second threshold value, in a case in which the absolute value of the difference between the current position and the estimated focusing position is less than the second threshold value while the focus lens is being moved at the second speed.

6. The focus control device according to claim 1,
wherein the processor is configured to:
derive the estimated focusing position a plurality of times while the focus lens is being moved at the second speed; and
stop movement of the focus lens in a case in which an absolute value of a difference between a previous estimated focusing position and a current estimated focusing position is less than a third threshold value.

7. The focus control device according to claim 1,
wherein the processor is configured to:
stop movement of the focus lens in a case in which it is determined that the current position passes beyond the estimated focusing position while the focus lens is being moved at the second speed.

8. The focus control device according to claim 7,
wherein the processor is configured to:
determine that the current position passes beyond the estimated focusing position in a case in which a sign of the difference between the current position and the estimated focusing position is reversed.

9. The focus control device according to claim 1,
wherein the processor is configured to:
cause the focus lens to stay at the current position in a case in which the absolute value of the difference between the current position and the estimated focusing position is less than a fourth threshold value; and
move the focus lens in a case in which the absolute value of the difference between the current position and the estimated focusing position is equal to or greater than the fourth threshold value.

10. An operation method of a focus control device comprising:
acquiring a current position of a focus lens and an estimated focusing position of the focus lens derived in a case in which the focus lens is located at the current position;
moving the focus lens at a first speed in a case in which an absolute value of a difference between the current position and the estimated focusing position is less than a first threshold value; and
moving the focus lens at a second speed lower than the first speed in a case in which the absolute value of the difference between the current position and the estimated focusing position is equal to or greater than the first threshold value.

11. A non-transitory computer-readable storage medium storing an operation program of a focus control device causing a computer to execute a process comprising:
acquiring a current position of a focus lens and an estimated focusing position of the focus lens derived in a case in which the focus lens is located at the current position;
moving the focus lens at a first speed in a case in which an absolute value of a difference between the current position and the estimated focusing position is less than a first threshold value; and
moving the focus lens at a second speed lower than the first speed in a case in which the absolute value of the difference between the current position and the estimated focusing position is equal to or greater than the first threshold value.

12. An imaging apparatus comprising:
the focus control device according to claim 1.
